(19) United States
(12) Patent Application Publication
(10) Pub. No.: US 2018/0019914 A1
(43) Pub. Date: Jan. 18, 2018

(54) SYSTEM AND METHOD FOR DOCUMENT PROCESSING JOB ACCOUNTING

(71) Applicants: Kabushiki Kaisha Toshiba, Minato-ku (JP); Toshiba TEC Kabushiki Kaisha, Shinagawa-ku (JP)

(72) Inventors: William Su, Riverside, CA (US); Surya Ravichandran, Mission Viejo, CA (US)

(21) Appl. No.: 15/211,095

(22) Filed: Jul. 15, 2016

(51) Int. Cl. H04L 12/24; H04L 5/00; H04N 1/00; H04L 29/12; G06F 3/12

(52) U.S. Cl. CPC H04L 41/082; H04L 61/2007; G06F 3/1231; H04N 1/00312; G06F 3/1204; H04L 5/0048; G06F 3/1294; H04N 2201/0039; H04N 2201/0094

(57) ABSTRACT

A system and method for network device oversight includes a processor on a network client configured to generate a network probe via a network interface. Network configuration data corresponding to a configuration of a plurality of network devices is stored in a memory. The processor receives response data from an associated network device responsive to the probe and the processor updates the network configuration, device configuration, device status or user data in accordance with the response data.

### TECHNICAL FIELD

This application relates generally to network device administration. The application is particularly applicable to automated recognition and association of network devices or users.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. Until more recent times, users, which may include individuals or groups such as employees, administrators or technicians administrators of networked MFPs also were generally in relatively fixed location. A user would typically communicate documents or other information from his or her office or workstation. An administrator or technician also would monitor devices from a workstation.

Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available.

Device networks are frequently located in environments, such as office environments, where machines are added, removed, restarted or reconfigured. Users may be authorized to use one or more devices, or one or more features of these devices. Users may also be added or deleted from network. New devices may need to be configured for use. These situations require substantial and constant oversight by administrators.

### SUMMARY

In accordance with an example embodiment of the subject application, a system and method for network device oversight includes a processor configured to generate a network probe via a network interface. Network configuration data corresponding to a configuration of a plurality of network devices is stored in a memory. The processor receives response data from an associated network device responsive to the probe and it updates the network configuration or user data in accordance with the response data.

### BRIEF DESCRIPTION OF THE DRAWINGS

Various embodiments will become better understood with regard to the following description, appended claims and accompanying drawings wherein:

FIG. 1 an example embodiment of a network monitoring, configuration, accounting system;

FIG. 2 is an example embodiment of a document rendering system;

FIG. 3 is an example embodiment of a digital device;

FIG. 4 is a block diagram of an example embodiment of software module blocks; and

FIG. 5 is a flowchart of an example embodiment of system operations.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with example embodiments herein, a network system functions to poll or discover network devices and device users. Device discovery enables a system to find MFPs and add them to a device list. When a network device, such as a multifunction peripheral, is connected to a network, the device can be automatically detected. Device information, such as model, user information, job count, job type, quotas, toner usage, paper usage, feature type used, or the like can be automatedly obtained and stored.

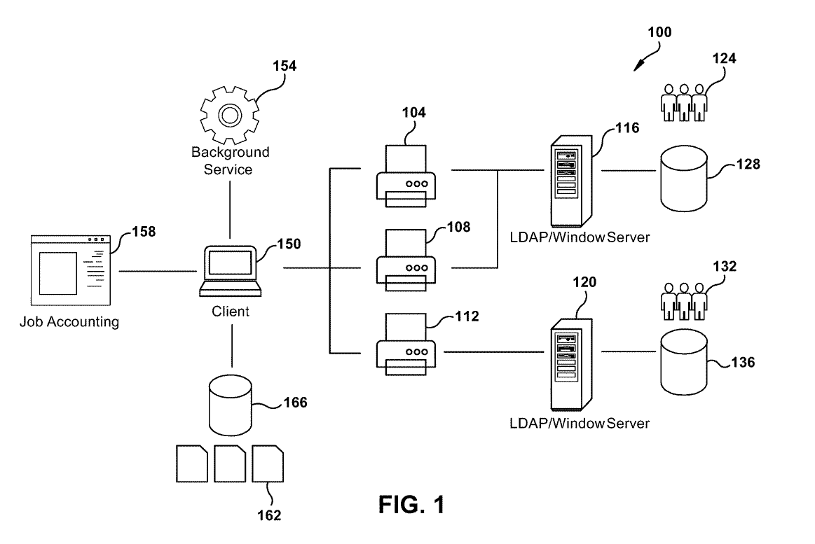

In accordance with the subject application, FIG. 1 illustrates an example embodiment of a network monitoring, configuration, accounting system 100. The system 100 includes one or more devices, such as MFPs 104, 108 and 112. The system 100 suitably includes one or more directory servers, such as lightweight directory access protocol (LDAP) servers 116 and 120. LDAP servers function to store directory information, such as device information and user information in a single or distributed server network. In the illustrated example, LDAP server 116 includes user information 124 on data storage 128 and LDAP server 120 includes user information 132 on data storage 136. User information may include identities and associated permissions for multiple users. LDAP servers may also store additional information, such as information identifying MFPs on the network, along with data associated with a state of features of such devices.

In the example of FIG. 1, a client device 150 is suitably comprised of any suitable digital data processing device, such as a workstation or administrative device. The client device 150 may also be integrated in one or more controllers of networked MFPs. Client device 150 operates a background service 154 that functions to generate probes to discover and identify devices or users that have been added to the network. Such devices may be new MFPs, or a reintroduction of a previously installed and identified MFP which had been reintroduced into the network with new features, or with a new address. By way of further example, an Internet Protocol (IP) address may be assigned to a device when it's added, or when an existing device is restarted. A job accounting 158 is made relative to discovered or identified devices, and network information 162 is suitably stored on data storage 166.

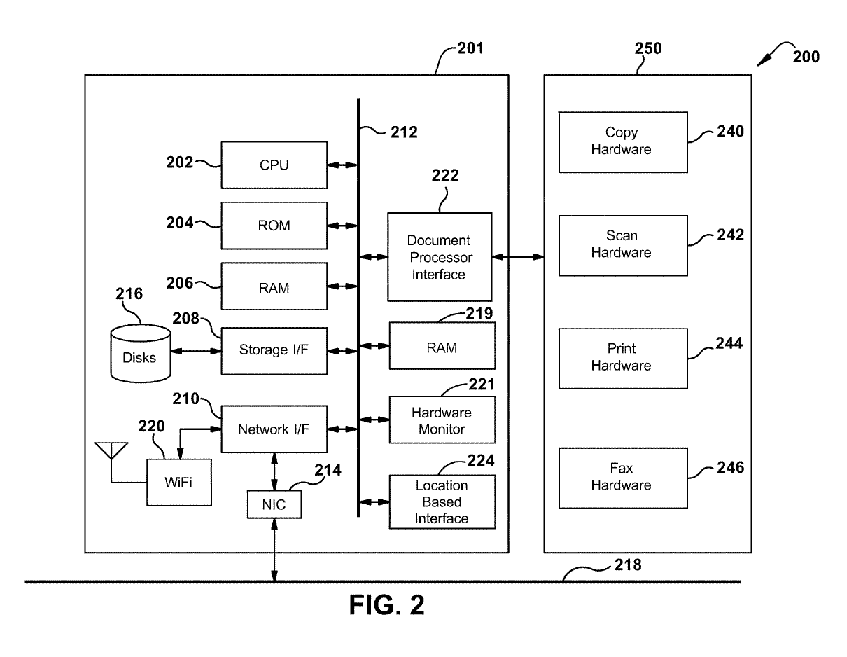

Turning now to FIG. 2, illustrated is an example embodiment of a document rendering system 200 suitably comprised within an MFP, such as with MFPs 104, 108 and 112 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 218, or to a wireless data connection via wireless network interface 220. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors 219 which provide data relative to a state of the device or associated surroundings, such as device temperature, ambient temperature, humidity, device movement and the like.

Processor 202 can also be in data communication with any suitable user input/output (I/O) interface which provides data communication with user peripherals, such as displays, keyboards, mice, track balls, touch screens, or the like. Hardware monitor 221 suitably provides device event data, working in concert with suitably monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216 of FIG. 2.

Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Additional interfaces are suitably provided within controller 201 including a location-based services (LBS) interface 224. Data relative to device location is suitably channeled to controller 201 vial LBS interface 224 from any suitable location system. By way of example, location may be determined by Global Positioning System (GPS) information, cellular location information or network location information, or a combination thereof. Location information is also suitably determined outside of the MFP, such as by a technician who inputs device location information directly to the device.

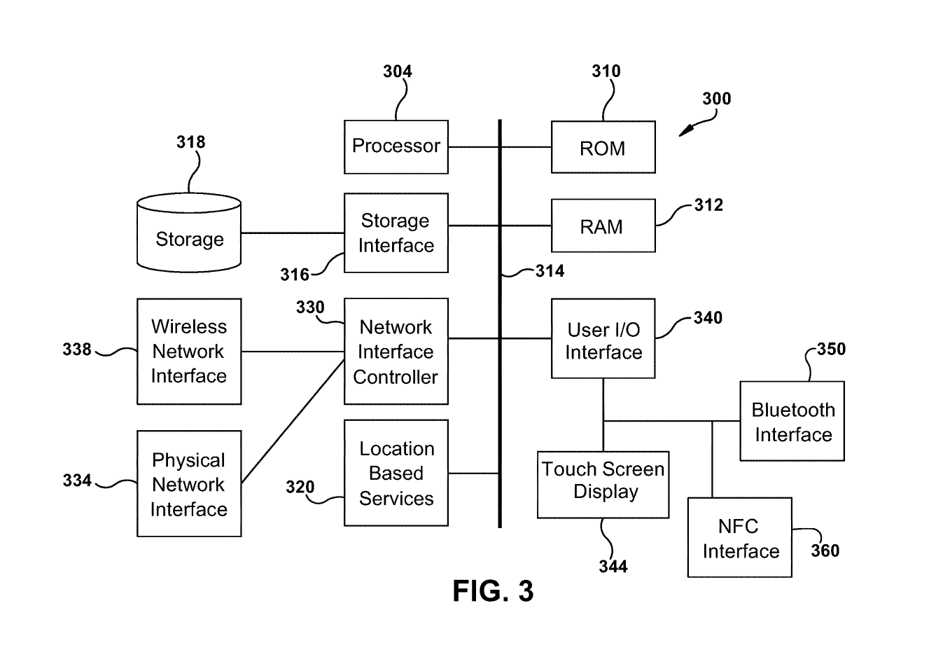

Turning now to FIG. 3, illustrated is an example embodiment of a digital device 300 such as client computer 150, workstation or smartphone, as well as LDAP servers 116 and 120 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338, such as one or more of the networks detailed above. The system suitably uses LBS services 320, such as those described above. By way of example, if multiple error event management systems are used, it may be advantageous to have monitoring of devices completed by a local or more proximate event management system.

Processor 304 is also in data communication with a user input/output (I/O) interface 340 which provides data communication with user peripherals, such as display 344, Bluetooth interface 350, and near-field communication interface 360, as well as keyboards, mice, track balls, touch screens, or the like. It will be understood that functional units are suitably comprised of intelligent units, including any suitable hardware or software platform.

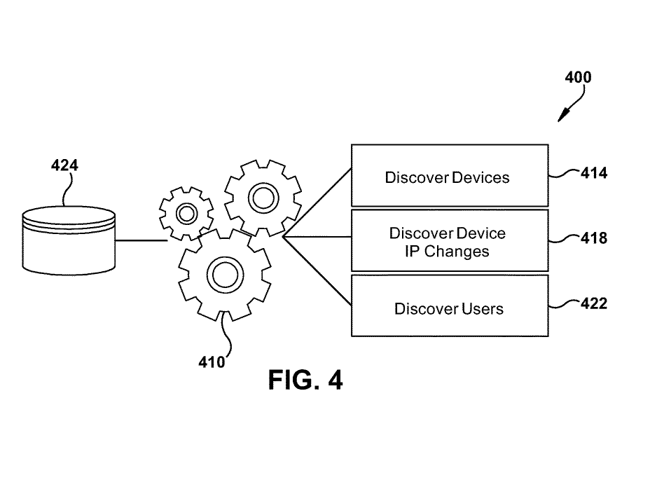

Turning now to FIG. 4, illustrated is a block diagram of example software module blocks 400 suitable for background service and job accounting on client computer 150 of FIG. 1. Background service 410 includes a module 414 to discover network devices, a module 418 to discover device IP changes and a module 422 to discover network users. Resultant network information is stored in data storage 424 associated with the client computer. Device or user discovery is suitably accomplished by generating a network probe for information through a network, or via a specified subnet. By way of further example, a client device may be preset with an IP address range. A ping of IP addresses within that range may return nothing, indicating that no device is currently associated with that IP address. A positive return on an address ping may prompt generation of a further probe to the associated address to determine and identify what device is associated with that address. The information may result in a determination that a device was newly added to the network or subnet. Corresponding device information is then retrieved and an update to the network information is made. A probe may determine that a particular device was already identified, but it is now associated with a new IP address. This updated information is then suitably stored in the data storage 424. If a device detected is an LDAP server, user information is suitably pulled from the server and added to the network information. New users may be added or deleted. Network information on the client is also suitably communicated to the LDAP server for updating if needed. Also, device configuration information may be provided from the client to a newly installed or modified device, such as an MFP, so as to allow for use without need for manual device configuration.

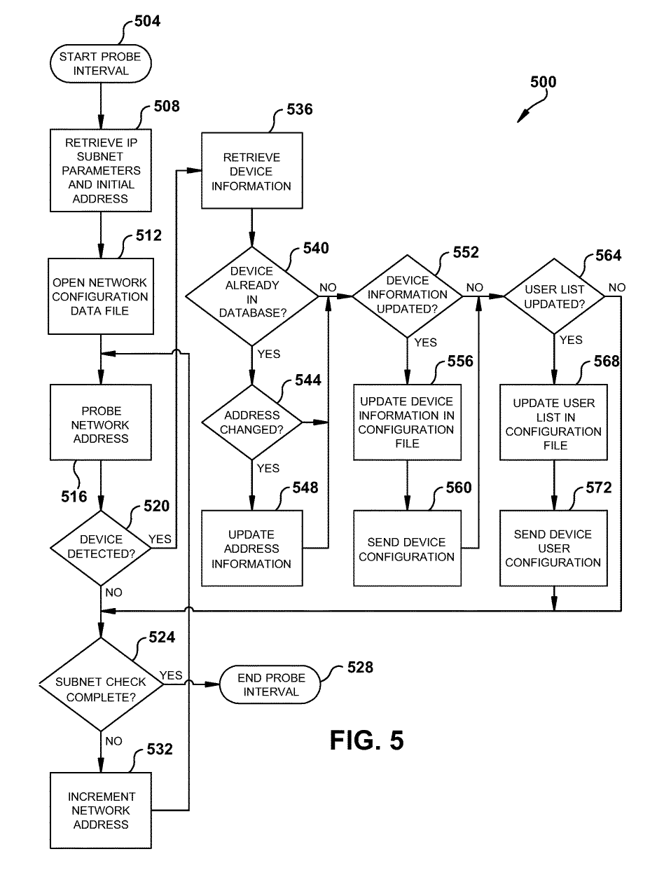

Referring next to FIG. 5, illustrated is a flowchart of example operations 500 of a network device for user monitoring and devices configuration suitable for operation on a client device such as client 150 of FIG. 1. A probe interval is commenced at 504. Intervals are suitably at preselected times, such as weekly, daily, or hourly. A probe interval may also be instituted by an administrator, with trigger events such as when the client receives information that a modification has been made to network devices or users. This may, by way of further example, be reported by device software after an MFP is connected to a network.

Next, network parameters setting boundaries of a network and initial address for checking associated with a client are retrieved at block 508. By way of example, parameters may include a subnet or IP address range or ranges. A network configuration file having information such as a list of identified network devices, configurations or user information is opened at block 512. A network probe is initiated at block 516. The network probe may be comprised of a prescribed data packet decodable by an network device, or alternatively test for device network presence using standard network protocols such as a ping. If no device is detected at the current address at block 520, a check is made at block 524 to determine if all addresses assigned to the client have been checked. If so, the probe interval is completed at block 528.

If it is determined at block 524 that more addresses remain for checking, the next address is initiated at block 532 and the process returns to block 516 for a probe of the new address, progressing as described above. If a device is detected at block 520, information is retrieved from that device at block 536. Such information may include a device identifier, device make or model number, device activity log, user list, device configuration, consumable levels, or the like. A check is made for an identified device at block 540 to determine if it already exists in the network configuration file. If so, a test is made at block 544 to determine if its address information, such as IP address, has been changed. Such a change may be attributed to a system restart or other modification to the device. If an address has been changed, the configuration data file is updated at block 548 and the process progresses to block 552 where a determination is made as to whether other device information has been updated. Block 540 also progresses to block 552 if it was determined that the device did not exist on the network before.

A check is made at block 552 as to whether device information has been updated, which would be case when a new device is added for the first time. If new or updated information is present, this is reflected in the configuration file at block 556. For new or modified devices, configuration information is suitably relayed to the device at block 560 to provide for background configuration of the device. Progress is then made to block 564, which destination is also resultant from a determination that no updated device information is present at block 552. A check is made at block 564 to determine if a user list is updated. This user list may be associated with devices such as an MFP, or single or distributed directory, such as an LDAP directory. If no update is detected, the process returns to block 524 and progresses as set forth above. If an update to the user list is detected, the configuration file is updated on the client computer at block 568, and modified user information suitably communicated from the client to the network device at 572. Thus, users may be automatically added or privileges or capabilities set for users. The process then returns to block 524 and progresses as set forth above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a network interface; and
a processor and associated memory,
the processor configured to generate a network probe via the network interface,
the memory configured to store network configuration data corresponding to a configuration of a plurality of network devices,
the processor further configured to receive response data from an associated network device responsive to the probe, and
the processor configured to update the network configuration data in accordance with the response data.

2. The system of claim 1 wherein the processor is further configured to periodically generate network probes to associated network devices in a selected network.

3. The system of claim 2 wherein the response data comprises a new address of the associated network device.

4. The system of claim 3 wherein the processor is further configured to communicate device configuration data to the associated network device in accordance with received response data.

5. The system of claim 3 wherein the response data comprises a new address of a second associated network device.

6. The system of claim 1 wherein the response data comprises user identification data corresponding to a new user of the associated network device.

7. The system of claim 6 wherein the processor is further configured to receive the response data from an LDAP directory on the associated network device.

8. A method comprising:
generating, by a processor, a network probe;
communicating the network probe to a network via a network interface;
storing network configuration data corresponding to a configuration of a plurality of network devices in a memory;
receiving response data from an associated network device responsive to the probe; and
updating the network configuration data in accordance with the response data.

9. The method of claim 8 further comprising periodically generating network probes to associated network devices in a selected network.

10. The method of claim 9 wherein the response data comprises a new address of the associated network device.

11. The method of claim 10 further comprising communicating device configuration data to the associated network device in accordance with received response data.

12. The method of claim 10 further comprising receiving response data comprised of a new address of a second associated network device.

13. The method of claim 9 wherein the response data comprises user identification data corresponding to a new user of the associated network device.

14. The method of claim 13 wherein the response data is received from an LDAP directory on the associated network device.

15. A system comprising:
a data storage including network configuration data corresponding to a configuration of a plurality of multifunction peripherals on a network subnet;
a directory server including at least one processor, memory and network interface,
the memory is configured to store a directory information corresponding to a plurality of network device users,
at least a first processor is configured to generate a periodic network probe to each address on the network subnet,
at least the first processor is configured to receive response data from at least one associated network device responsive to the probe,
at least the first processor is configured to update the network configuration data in accordance with the response data, and
at least the first processor is configured to update the network configuration data in accordance with the directory information.

16. The system of claim 15 wherein the response data is comprised of an internet protocol address associated with an identified multifunction peripheral.

17. The system of claim 16 wherein at least the first processor is further configured to update the network configuration data by assigning a new internet protocol address with data from a previously identified multifunction peripheral.

18. The system of claim 16 wherein at least the first processor is further configured to communicate directory information to the identified multifunction peripheral.

19. The system of claim 16 wherein at least one processor is configured to communicate device configuration data to the identified multifunction peripheral.

20. The system of claim 19 wherein at least one processor is configured to communicate directory information to the identified multifunction peripheral.
